(19) United States
(12) Patent Application Publication
(10) Pub. No.: US 2017/0085509 A1
(43) Pub. Date: Mar. 23, 2017

(54) SEMANTICS CLASSIFICATION AGGREGATION NEWSFEED, AN AUTOMATED DISTRIBUTION METHOD

(71) Applicants: VICENTE FERNANDEZ, Miami, FL (US); Paul Briz, Miami, FL (US); Ramon Branger, Miami, FL (US)

(72) Inventors: VICENTE FERNANDEZ, Miami, FL (US); Paul Briz, Miami, FL (US); Ramon Branger, Miami, FL (US)

(21) Appl. No.: 14/856,760

(22) Filed: Sep. 17, 2015

(51) Int. Cl. H04L 12/58; H04L 29/08

(52) U.S. Cl. CPC H04L 51/12; H04L 51/32; H04L 51/046; H04L 67/26

(57) ABSTRACT

A method of stripping/filtering and distribution of news social media content. More particular, the present invention pertains to a method for the real-time distribution of news social media content to users by filtering irrelevant and duplicate information. The inventions herein (both software and hardware embodiments) create the ability to filter news from social media sources and deliver accurate personalized news. The data that will be filtered include: video, photos, voice and sound recordings, and text. All of the data, paint a vivid picture of what is happening in real-time and as the filtering process is complete, the social media content consumer is informed of what he or she really wants to hear and no more.

### CROSS-REFERENCE TO RELATED APPLICATION

Not applicable.

### FIELD OF THE INVENTION

The present invention relates to a method for stripping/filtering and distributing news and social media content. More particular, the present invention pertains to a method for the real-time distribution of news and filtered social media content to users by filtering irrelevant and duplicate information.

### BACKGROUND OF THE INVENTION

The digital age has not only revolutionized the way news is disseminated (virally and immediately), but also the way in which people consume it. Thanks to the instant publishing capabilities of social media like TWITTER, FACEBOOK, INSTAGRAM, etc. regular people are able to individually broadcast as events unfold in real-time across the globe.

Half of social media site users have shared news stories, images or videos, and nearly as many as 46% have discussed a news issue or event. In addition to sharing news on social media, a small number are also covering the news themselves by posting photos or videos of news events. This practice has played a role in every breaking news events in the past few years. Research found that in 2014, 14% of social media users posted their own photos of news events to a social networking site, while 12% had posted videos. For millennials aged 14 to 25, TV and social media are even in regards to their main source for news, hence, TV may soon disappear as the dominant news medium in the United States.

One of the problems that social media has as news and content provider is repetitiveness, speculation, and credibility. With 500 million Tweets a day, about 5,700 Tweets a second, TWITTER will not become its own credible news outlet overnight. One of the problems is that it is sometimes more important to get the news out in real time, even if the facts are not yet confirmed. Credibility of media, and the information it releases, poses a major question to the people when there is so much un-verified data of information out there. With this fast digital moving age, and with its time constraints, people are turning towards social media for news about their communities; favorite sports teams, finances, and their world around them. If this information has the potential of being false, then all the decisions taken on the basis of this misinformation could have devastating consequences. Political events, economic events, entertainment, sports, and social events, affect a person's life directly, hence it is important to have access to the most accurate and true information quickly.

Traditional news delivery is losing ground, but not when it comes to verified sources, credibility, and a contextualized perspective. Hence, there is a need in the industry to close this gap, to use the real time advantage of social media but at the same time filtering or stripping social media content that is repetitive, speculative, and non-relevant, to bring the same level of credibility to social media as regular news outlets. The problem with the verification of sources and credibility checks is that it consumes a lot of time. Hence, once the verification process is complete, the advantage of sending the news real-time through social media is lost.

Another problem with the current distribution of news and social media content is that news is broadcast to a broad spectrum of people and is up to the individual consumer to filter what news to assimilate. What is needed is the opposite, to use social media to dispense and consume accurate information to and by the general population in individualized way. News outlets can use social media as a tool to reach a bigger audience in real-time, but what is needed is news that is screened and personalized to a particular consumer.

Therefore, a need exists to overcome the problems with the prior art as discussed above.

### SUMMARY OF THE INVENTION

The invention provides a Semantics Classification Aggregation Newsfeed, an Automated Distribution Method that overcomes the hereinabove-mentioned disadvantages of the heretofore-known methods of this general type. With the foregoing and other purposes in view, there is provided, in accordance with the invention, a method of stripping, aggregation, and distribution of posted social media content, the method that includes: receiving posted social media content; and filtering the posted social media content providing computational models to do the following: (a) train and learn from a collection of posted social media content; (b) recognize patterns in language from the collection of posted social media content; (c) decide when the posted social media content is duplicative, speculative, or a rumor; and (d) match the filtered social media content with a user to deliver filtered (personalized) social media content in real-time.

In accordance with another feature, an embodiment of the present invention includes identifying the relevant users to receive the filtered social media content; creating user notifications for the relevant users; and pushing the filtered social media content with the user notification to a plurality of mobile devises.

In accordance with a further feature of the present invention, the filtered social media content is sent to at least one website or to at least one mobile device and the social media content includes: breaking news, sport news, financial news, and any combinations thereof.

In accordance with a further feature of the present invention, wherein the method is designed for fantasy sports leagues.

In accordance with the present invention, a method for of stripping, aggregation, and distribution of “raw” or a posted social media content, the method includes: receiving the posted social media content; filtering the posted social media content received from social media sources providing computational models to do the following: (1) transforming the posted social media content into Bigrams and Trigrams; (2) training a Term Frequency-Inverse Document Frequency (TF-IDF) model to learn the semantic contribution each word plays in the posted social media content; (3) representing the semantics of a word as a vector using a Word Vector Model; (4) representing the posted social media content as a vector using a Tweet Vector Model; and (5) predicting the topic of a filtered social media content providing a generative probabilistic computational model that uses a Topic Model that includes: (a) at least one neural network; and, (b) at least one process that uses cosine distance to identify posted social media content as repeat.

The at least one neural network uses supervised learning to classify the topics of tweets.

In accordance with yet another feature, an embodiment of the present invention includes: (1) identifying the relevant users to receive a filtered social media content; (2) creating user notifications for the relevant users; and (3) pushing the filtered social media content with the user notification sent to a plurality of mobile devices.

In accordance with a further feature of the present invention, the filtered social media content is sent at least one website or at least one mobile device.

In accordance with the present invention, a method for of stripping, aggregation, and distribution of posted social media content, the method includes: (1) providing the social media content provider with notoriety by filtering the posted social media content providing computational models to do the following: (a) training and learn from a collection of posted social media content; (b) recognizing patterns in language from the collection of posted social media content; (c) deciding when the posted social media content is duplicative; and (d) matching the filtered social media content with a user to deliver personalized social media content in real-time; and (2) distributing the social media content real-time to all subscribed followers in a database.

Although the invention is illustrated and described herein as embodied in a Semantics Classification Aggregation Newsfeed, an Automated Distribution Method, it is, nevertheless, not intended to be limited to the details shown because various modifications and structural changes may be made therein without departing from the spirit of the invention and within the scope and range of equivalents of the claims. Additionally, well-known elements of exemplary embodiments of the invention will not be described in detail or will be omitted so as not to obscure the relevant details of the invention.

Other features that are considered as characteristic for the invention are set forth in the appended claims. As required, detailed embodiments of the present invention are disclosed; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one of ordinary skill in the art to variously employ the present invention in virtually any appropriately detailed structure. Further, the terms and phrases used herein are not intended to be limiting; but rather, to provide an understandable description of the invention. While the specification concludes with claims defining the features of the invention regarded as novel, it is believed that the invention will be better understood from a consideration of the following description in conjunction with the drawing figures, in which like reference numerals are carried forward. The figures of the drawings are not drawn to scale.

Before the present invention is disclosed and described, the terminology used is for the purpose of describing particular embodiments only and is not intended to be limiting. The terms “a” or “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The term “coupled,” as used herein, is defined as connected, although not necessarily directly, and not necessarily mechanically.

As used herein, the terms “about” or “approximately” apply to all numeric values, whether or not explicitly indicated. These terms generally refer to a range of numbers that one of skill in the art would consider equivalent to the recited values (i.e., having the same function or result). In many instances these terms may include numbers that are rounded to the nearest significant figure.

The terms “program,” “software application,” “mobile application,” “application,” and the like as used herein, are defined as a sequence of instructions designed for execution on a computer system or mobile device. A “program,” “computer program,” “mobile application,” “application,” or “software application” may include a subroutine, a function, a procedure, an object method, an object implementation, an executable application, an applet, a servlet, a source code, an object code, a shared library/dynamic load library and/or other sequence of instructions designed for execution on a computer system or mobile device.

In this document, the term “real-time,” should be understood to the actual time during which a process or event occurs or relating to a system in which input data is processed within a short amount of time so that it is available virtually immediately as feedback.

In this document, the term “Social media” is defined as a group of Internet-based applications that builds on ideological and technological foundations, and that allow the creation and exchange of user-generated social media content to be disseminated to other users in real-time. As a non-limiting example, it includes: TWITTER, FACEBOOK, INSTAGRAM, and more.

The term “push” and “pushing” “server push notification,” should be understood to mean the delivery of information, social media content, or data from a software application to a computing device without a specific request from the user, computer, or mobile device.

In this document, the term “mobile device” “mobile devices” should be understood to mean a handheld computer or a handheld computing device of any size, typically having a display screen with touch input screen and/or a miniature keyboard. A mobile device as disclosed herein should not be limited to IPHONE or ANDROID mobile phones or tablet devices.

### BRIEF DESCRIPTION OF THE DRAWINGS

The accompanying figures and reference numerals refer to identical or functionally similar elements throughout the separate views and which together with the detailed description below are incorporated in and form part of the specification, serve to further illustrate various embodiments and explain various principles and advantages all in accordance with the present invention.

FIG. 1 illustrates a flow diagram providing a sequence of steps in a method to strip, aggregate, and distribute personalized news social media content in real-time;

FIG. 2 illustrates a flow diagram providing an alternative embodiment from the method previously described in FIG. 1, a method to strip, aggregate, and distribute personalized news social media content in real-time;

FIG. 3 illustrates a flow diagram providing a more detailed description of the processing step previously introduced in FIGS. 1-2;

FIG. 4 illustrates a flow diagram providing a more detailed description of the mobile app and website previously introduced in FIGS. 1-2;

FIG. 5 illustrates an exemplary website to distribute relevant, accurate personalized news social media content to a mobile device;

FIG. 6 illustrates an exemplary mobile app to distribute relevant, accurate personalized news social media content to a mobile device; and

FIG. 7 is flow diagram providing a sequence of steps in a method to generate social media content for the news feed using exposure-payback method.

### DETAILED DESCRIPTION

While the specification concludes with claims defining the features of the invention regarded as novel, it is believed that the invention will be better understood from a consideration of the following description in conjunction with the drawing figures, in which like reference numerals are carried forward. It is to be understood that the disclosed embodiments are merely exemplary of the invention, which can be embodied in various forms.

As explained above, current newsgathering and mass distribution is losing audiences because the news are generalized to wide audience, and because it's relatively slow, and no matter how verified and accurate the social media content is, people want it fast. There is a need to create the opposite, a personalized social media content service that is verified and accurate that delivers speculation-free social media content in real-time.

The invention herein (both software and hardware embodiments) creates the ability to filter news from social media sources and deliver accurate personalized news. The data that will be filtered include: video, photos, voice and sound recordings, and text. All of the data, paint a vivid picture of what is happening in real-time and as the filtering process is complete, the social media content consumer is informed of what he or she really wants to hear and no more.

The following are many non-limiting examples for the type of real-time “social media content” that is gathered, filtered, and distributed embodied in the specification and the claims:

Breaking news events, such as: wars, assassinations of political and public figures, verdicts in public trials, national disasters, fatal accidents, presidential announcements, celebrity rumors and more.

News in Sports, such as: team statistics, team scores, team drafts, individual player news, team and player rumors, player injuries, and more. A user will have the choice to get personalized information about his or her favorite team in real-time. Filtered customized social media content is particularly useful for Fantasy Sports leagues and people that engage in sports' gambling.

Financial news such as: stock reports, bond reports, commodities reposts, a public company's financial statements, a public company's rumors, a public company's sales data, rumors about the Federal Reserve, monetary and foreign exchange fluctuation reports, and more.

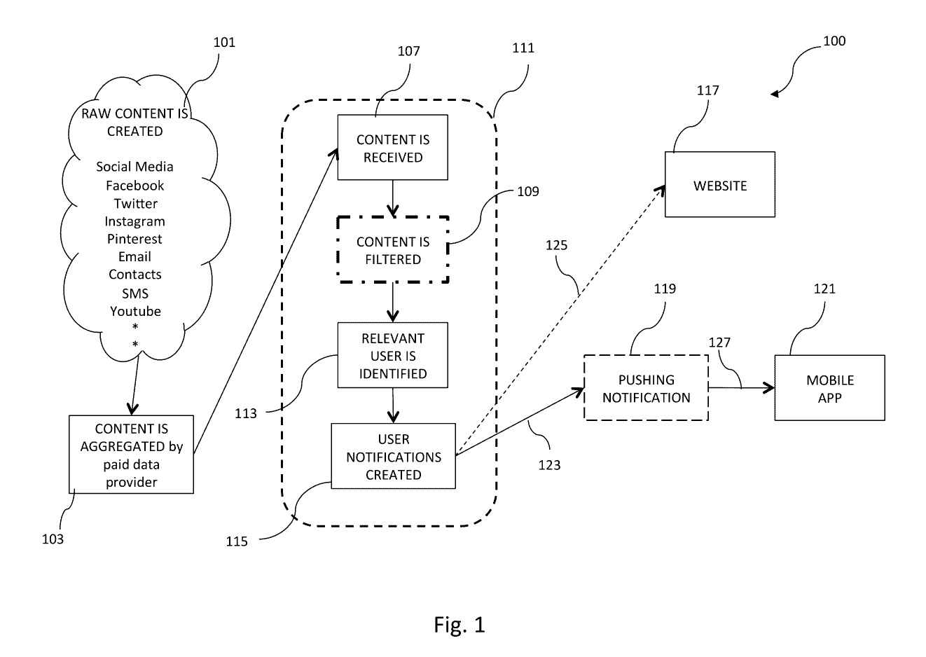

FIG. 1 is a flow diagram that depicts the automated stripping, aggregation, and distribution newsfeed method 100. Here, in this embodiment, the method includes the following steps: (1) receiving 107 social media content from data providers 103 who in turn aggregates social media content from social media 101; (2) filtering 109 the social media content received from data providers 103; (3) identifying 113 relevant users; (4) creating 115 user notifications; (5) pushing 123 the user notifications 119; and (6) receiving 127 the pushed the social media content by the user of a mobile app 121. In the alternative 125 to steps (5) and (6) the server 111 can send the filtered social media content after step (4) directly to the alternative step (5) to a receiving website 117 after the user has logged on. Here, the news social media content from social media is transformed from being in its “raw” state (in step 1), into being clean (in step 6 for an app) or alternative (step 5 for a website), free from duplicate social media content, speculative, irrelevant social media content as related to the topics selected by a user, so that untrue or rumors can be identified.

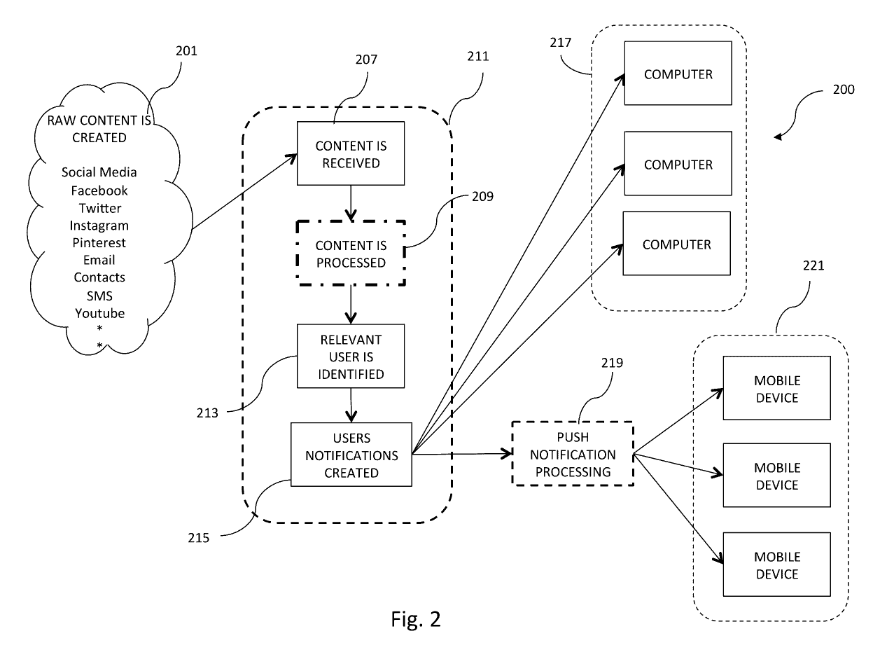

FIG. 2 depicts a flow diagram providing an alternative-method 200 for the automated stripping, aggregation, and distribution newsfeed method previously featured in FIG. 1 as 100. Here, the method include the following steps: (1) receiving 207 posted social media content from social media 201; (2) filtering 209 the posted social media content received from social media 201; (3) identifying 213 relevant users; (4) creating 215 user notifications; (5) pushing 219 the user notifications; and (6) receiving 221 the pushed the posted social media content by more than one user of to multiple mobile devices. In the alternative to steps (5) and (6) the method can send the filtered social media content, after step (4), directly to the alternative step (5) to multiple receiving computers 117 after the users have logged on.

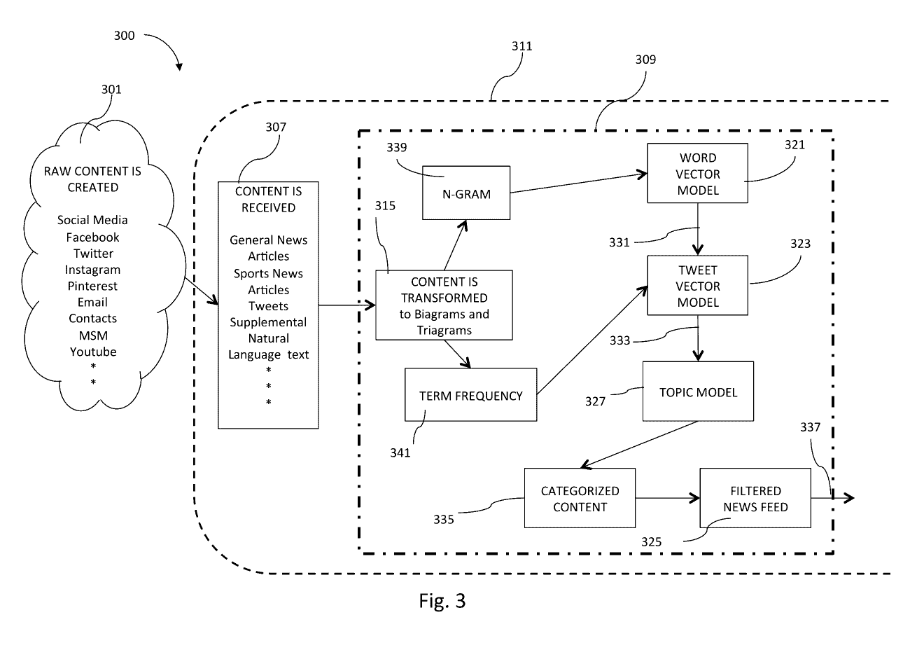

FIG. 3 illustrates flow diagram 300 providing a more detailed description of the processing step 309 inside sever 311 previously introduced as numbers 109 and 209 in FIGS. 1-2. One of the purposes of the processing step 309 is to analyze the language of a posted social media content and recognize the trusted data sources. A trusted data source allows a user to differentiate between, duplicates, rumors, speculation or uncertainty in the posted social media content. As it will be explained in detail below, the processing step 309 will in general: (1) train and learn from a collection of posted social media content, (2), recognize from patterns in language, (3) decide when the posted social media content is duplicative, a rumor, or an actual news, and (4) match the filtered social media content with a user to deliver personalized social media content.

In addition in FIG. 3, the filtering and transformation process step 309 is detailed as follows: (1) the “raw” posted social media content or training data is received 307 from social media 301; (2) the posted social media content is then transformed into Bigrams and Trigrams 315 in the N-gram Model; and then the posted social media content takes two routes: (3A) is the first route as a Word Vector Model where the posted social media content is generalized to a vector representation shown in numeral 321, and the second route, (3B), is a Term Frequency-Inverse Document Frequency (TF-IDF) model shown in numeral 341. From the N-Gram model 315 the posted social media content is then generalized to a Vector representation using the Word Vector Model 321 step (3A). Alternatively, from the TF-IDF model in numeral 341, in step (3B), a Tweet Vector Model 323 is created here a vector represents each tweet or posted social media content. Both from the TF-IDF model, step (3B), or the Word Vector Model 321, step (3A), a Tweet Vector Model 323 is created at step (4). This in turn is filtered through the Topic Model 327, step (5), of hierarchically structured neural networks and then the final filtered transformed categorized social media content data 335 is created at step (6). From the categorized data 335, at step (6), now the filtered news feed is created 325 at step (7), and ready to be sent out 337 to be coupled with the user identification step 213 previously shown in FIG. 1 and FIG. 2.

The following will explain the nature of each of the different computational “models” used in the filtering process to transform and eliminate repeated and irrelevant social media content inside the processing step 309 shown in FIG. 3. Computational models are mathematical models in computational science that requires computational resources to study the behavior of a complex system by computer simulation. Rather than deriving a mathematical analytical solution to the problem, experimentation with the model is done by adjusting the parameters of the system in the computer, and studying the differences in the outcome of the experiments. Here, adjusting is achieved both automatically and manually.

The n-gram model 339, shown in FIG. 3, is a type of probabilistic language model for unifying commonly co-occurring words as a single token. The N-Gram method 339 includes a bigram and a trigram model, and is constructed using the social media content data and is based on a phrase detection method that joins together two tokens when their co-occurrence score is above a certain threshold, where a delta variable is used as a discounting coefficient (i.e. minimum number of occurrences to be considered). This is in order to treat multiple word terms as a single semantic token.

Similarly, the Term Frequency Inverse Document Frequency (TF-IDF) computational model 341, shown in FIG. 3, uses the n-gram transformed social media content data and is used to provide a context for how much each token contributes to the composite semantics of the overall social media content data. This is in order to mine and find a numerical statistic that is intended to reflect how important a word is to a document in a collection, for example the term “the” is so common, this will tend to incorrectly emphasize documents which happen to use the word “the” more frequently, without giving enough weight to the more meaningful terms “brown” and “cow”. The term “the” is not a good keyword to distinguish relevant and non-relevant documents and terms, unlike the less common words “brown” and “cow.” Hence an inverse document frequency factor is incorporated which diminishes the weight of terms that occur very frequently in the document set and increases the weight of terms that occur rarely.

The Word Vector Computational Model 321, shown in FIG. 3, is a vector space model of semantics, where a high dimensional vector represents each word. Constructed using a Skip-gram Word2Vec method, and implemented using the Gensim Python library, the Word Vector Model Computational Model 321 also uses the previously described n-gram model to transform the social media content data 339. It is understood that other libraries other than the Gensim Python library can be used for the same purpose to achieve the same result. For example, word vectors have a dimensionality and are constructed such that words that occur in similar context will be mapped to vectors that have a small cosine distance. Relevance rankings of words in a keyword search can be calculated, using the assumptions of document similarities theory, by comparing the cosine distances between each word vector and the original query vector where the query is represented as the same kind of vector as the documents.

The Tweet Vector Computational Model 323, shown in FIG. 3, is a way to model individual tweets. The Tweet Vector Model 323 is similar to the previously described a word vector model 321. Here, a vector represents the composite se-mantics of a 140-character tweet. As a non limiting example, this model could use a modified Chinese Restaurant Process method for unsupervised (automated) clustering of semantically similar words. This is a probabilistic clustering method that places word vectors with a smaller cosine distance in the same cluster. It is envisioned that other probabilistic models could be used for the same purpose and to obtain the similar result. In the end, the cluster with the highest cumulative TF-IDF 341 score is used to construct the vector representation of the tweet. The tweet vector is the sum of each word vector from the winning table, multiplied by its respect Term Frequency IDF score, and then scaled to unit length.

The Topic model 327 of FIG. 3 is a generative probabilistic computational model that uses supervised learning to predict the topic of new tweets. The topic model 327 consists of hierarchically structured neural networks that are used to classify tweets, first as to which category they belong to (ex. a sports league such as the NHL, NBA, etc.) and then passing on the data to separate neural networks lower in the hierarchy for further classification of sub-topics (ex. specific team within a sports league). Each neural network in the hierarchical structure is trained on different parts of the gold standard dataset, and is constructed in a tree structure, where each network can have multiple children that further classify the data into sub-categories. A tweet being classified by the topic model proceeds down the tree structure, based on the category label assigned by the previous neural network. Each neural network is updated incrementally as the Gold Standard dataset develops.

The Gold Standard data set is the training data used to train the Neural Network categorization Topic Model 327. Training data is gathered from the Twitter API, in order to train the Topic Model 327. This dataset uses keywords and usernames to construct a labeled dataset of tweets, which are then used in a supervised machine-learning framework for training the classification Topic Model 327. The training data after the tweet vector model has transformed it consists of an n-x 300 arrays of n-vectorized tweets, and an n-length label vector containing integers that map to the gold standard topic for each tweet. The gold standard dataset is a dynamic dataset, and expands over time as new tweets become available. Also, the keywords and usernames are the result of a panel of experts, and evolve over time.

Finally, the Filtered News Feed 325 is the process responsible for generating the news feed utilizes the topic labels assigned by the topic computational model to give users topically relevant tweets. From the set of tweets that match the users selected topic profile, a probabilistic sampling method could be used, and as a non-limiting example the Markov Chain Monte Carlo (MCMC) was used to eliminate the possibility of presenting repeat social media content. It is envisioned that other probabilistic sampling methods could be used for the same purpose and to achieve a similar result. The MCMC is based on the concept that tweet vectors with very low cosine distance represent repeat social media content. Thus, the MCMC sampling method is designed to prevent from sampling multiple times from the same neighborhood in the vector space.

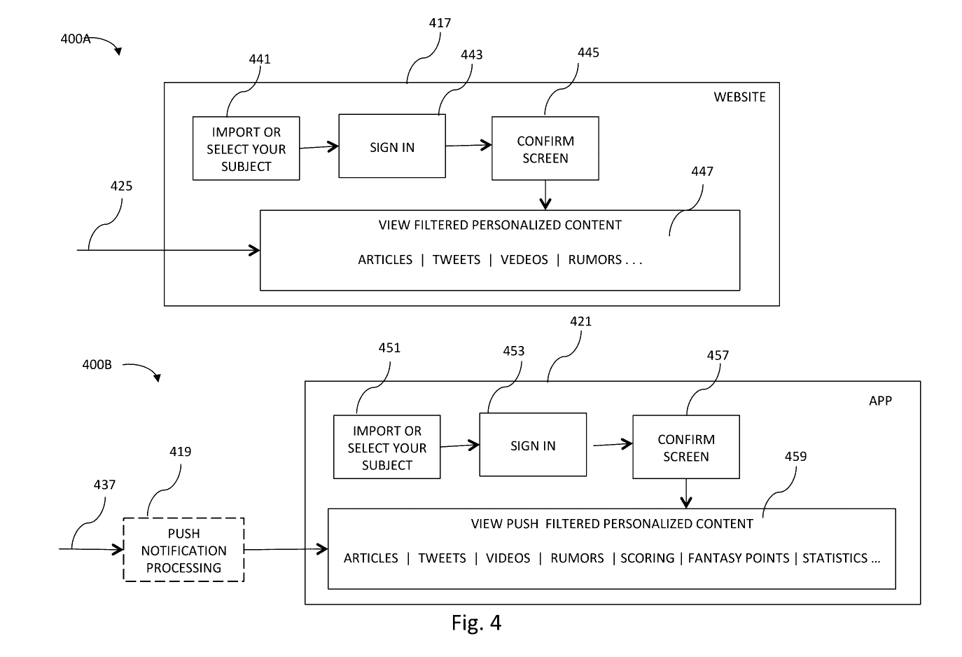

After the filtering process 300, previously described in FIG. 3, now here in FIG. 4, flow diagram 400A shows how the filtered social media content 425 is sent to a computer website 417. Inside the website 417, the user will be able to do the following: (1) logon/sign in 443; (2) import or select personalized subject 441; (3) confirm screen 445; and (4) view filtered personalized social media content 447 such as articles, tweets, video, rumors and more. Similarly, after the filtering process 300 previously described in FIG. 3, now here in FIG. 4, flow diagram 400B shows how the filtered social media content 437 is pushed through the push notification-processing step 419 to a mobile device app 421. Inside the app the user will be able to do the following: (1) sign in 453; (2) import or select personalized subject 451; (3) confirm screen 457; and (4) view filtered personalized social media content 447 such as articles, tweets, video, rumors and more.

In one embodiment of the invention, the automated stripping, aggregation, and distribution newsfeed method 100, 200, and 300, previously described in FIGS. 1-3, can be implemented for users that play in fantasy sports leagues. A fantasy sport league is a game where participants act as owners to build a team that competes against other fantasy owners based on the statistics generated by the real individual players or teams of a professional sport. Probably the most common variant converts statistical performance into points that are compiled and totaled according to a roster selected by a manager that makes up a fantasy team. These point systems are typically simple enough to be manually calculated by a “league commissioner.” More complex variants use computer modeling of actual games based on statistical input generated by professional sports. In fantasy sports there is the ability to trade, cut, and sign players, like a real sports owner.

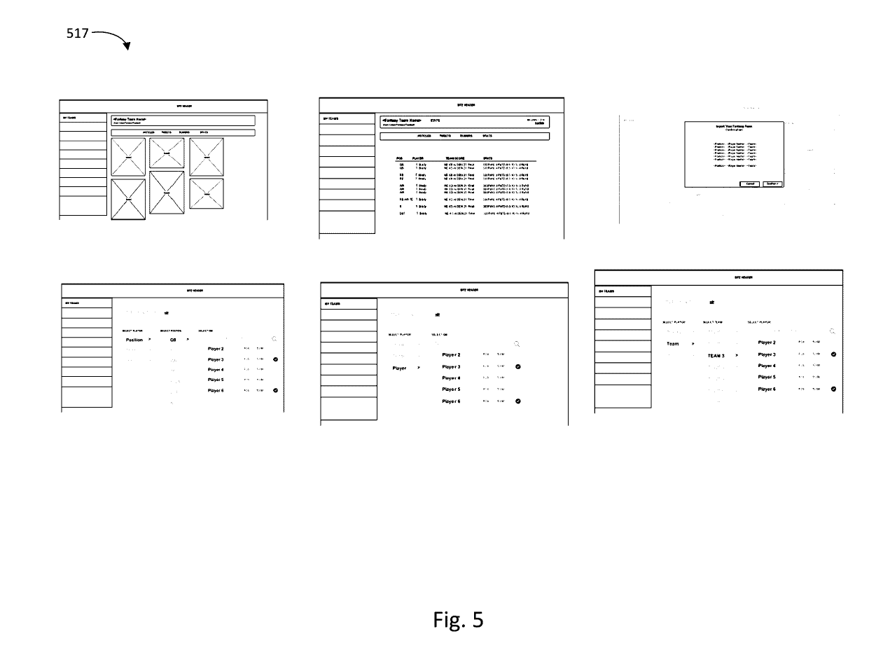

In the embodiment shown in FIG. 5, the website 517 shows a series of screen shots of the website 517 as designed. Here, the user will be able to do the following when using website 517: (1) Import a fantasy league 551, and select from a list of leagues such as ESPN, Yahoo, CBS Sports, NFL.com, Fox Sports, FanDuel, Draft Kings and even add user's own league where users pick players one by one previously shown as numeral 441 in FIG. 4; (2) Sign-in 553 using a personalized user name and password previously shown as numeral 443 in FIG. 4, using a personalized user name and password; (3) Confirm 557 the screen that contain a list of players and team name, the team logo, and the league scoring rules; and (4) get a “Team Feed” that is push-fed social media content 559 in real-time, under favorites.

After the sign in, the user is able to confirm the screen that contains a list of players and team name, the team logo, and the league scoring rules. Here, the “Team Feed” under favorites shows the team logo, and team feed name, which would be the user's fantasy team name. If a user adds more than one fantasy team, then the website will have separate feeds for each fantasy team avoiding all fantasy players lumped together.

Furthermore, in this embodiment shown in FIG. 5, the user is able to view the filtered social media content such as: Articles where the feed would be comprised of every time a user's fantasy player is mentioned by one of the sources who covers that fantasy player's real team. As a non-limiting example, when a player such as Matt Forte is either (1) mentioned by a Bears source on SM, or (2) when the fantasy player tweets themselves, or (3) if Matt Forte tweets, or (4) when a national source mentions the Matt Forte, or (5) when one of the “NFL” or “Fantasy Football” sources mentions Matt Forte, then (6) the filtered social media content will display Articles, Tweets, Rumors, and Videos, and more about Matt Forte on the website.

Another type of filtered social media content fed in real-time include statistics such as a Box Score of the user's team performance for the week. As a non-limiting example this includes: completions/pass attempts, yards, touchdowns, interceptions, fumbles, rushing attempts, average, fumbles, receiving targets, receptions, and more. The website 517 will automatically update user's teams throughout season. As another non-limiting example: if a user adds player Arian Foster and drops player Adrian Peterson in their fantasy league, the system would add Arian Foster to their feeds and box score in their fantasy web page, and remove Adrian Peterson (without them having to do it manually). The same principle applies if a user's fantasy team changes because of a trade.

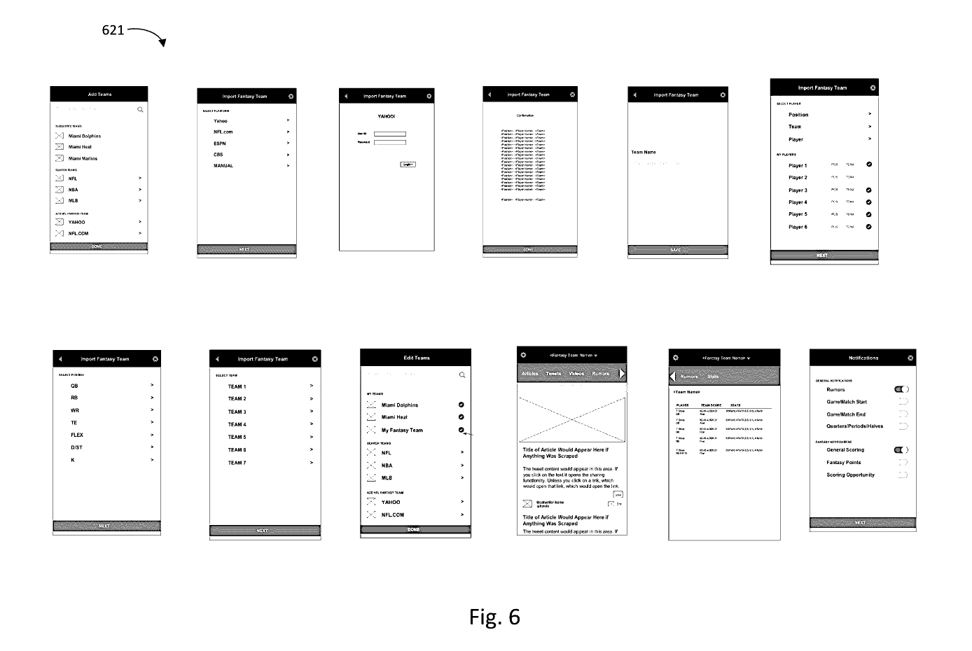

In another embodiment of the present invention, FIG. 6 provides screen shots of the mobile device app 621, shown previously in FIGS. 1-4 as 121, 221 and 421. Here, by using mobile device app 621, the user will be able to: (1) Import a fantasy league 651, or select from a list of leagues such as ESPN, Yahoo, CBS Sports, NFL.com, Fox Sports, FanDuel, Draft Kings and even add user's own league where users pick players one by one; (2) Sign-in 653 using a personalized user name and password; (3) Confirm 657 the screen that contain a list of players and team name, the team logo, and the league scoring rules; and (4) get a “Team Feed” that is push-fed social media content 659 in real-time, under favorites. The Team Feed will have the team logo, and the Team Feed name would be the users' fantasy team name. If a user adds more than one fantasy team, there will be separate push-feeds for each fantasy team.

One of the inventive features is that the user receives a real-time push notification every time one of their players score a touchdown or hits a significant statistical milestone. For example, touchdowns, every 100 passing yards, every 50 rushing yards, every 50 receiving yards etc. The following are non-limiting examples:
1) Passing Stats Yards Notification Player surpasses 100 yards passing in the game (shows total # of yards) Every 100 Yards (100, 200, etc.) Example: “Tom Brady has passed for over 100 yards (112 yds.), 3:49 1st Qtr.”
2) Passing TD Notification Player throws a touchdown pass (shows length of pass) Example: “Tom Brady TD pass (32 yds.), 3:49 1st Qtr.”
3) Rushing Stats Yards notification Player surpasses 50 rushing yards in the game (shows total # of yards) Every 50 Yards (50, 100, 150, 200, etc.) Example: “Lamar Miller has rushed for over 50 yards (59 yds.), 3:49 1st Qtr.”
4) Rushing TD Notification Player rushes for a touchdown (shows length of run) Example: “Lamar Miller TD run (32 yds.), 3:49 1st Qtr.”
5) Receiving Stats Yards notification Player surpasses 50 receiving yards in the game (shows total # of yards) Every 50 Yards (50, 100, 150, 200, etc.) Example: “Mike Wallace has over 50 yards receiving (59 yds.), 3:49 1st Qtr.”
6) Receiving TD Notification Player receives a touchdown pass (shows length of reception) Example: “Mike Wallace TD catch (32 yds.), 3:49 1st Qtr.”
7) Defensive Stats TD Team Scores a TD (shows length of TD) Example: “GB Defensive TD (32 yards), 3:49 1st Qtr.”
8) And more.

Another inventive feature of the invention is that the user receives a real-time push notification every time his players score fantasy points. This would be based off the specific scoring rules for the fantasy league to which the user's imported fantasy team belongs. With this type of notification turned on a user would receive a notification every catch in a Points Per Reception league, every 10 yards rushing in a standard league (since 10 yards rushing equals one point in a standard league), etc. The push notification would include details about the other field statistic and how many fantasy points that means for the user. The following are non limiting examples:
1) Passing Stats Yards Notification. When a player scores fantasy points every x-yards passing in the game x could vary depending on league scoring every 10 yards (10, 20, etc.), 25 yards (25, 50, etc.), etc. Example: “Tom Brady completes 5 yard pass, totaling 57 passing yds., 3:49 1st Qtr. (+0.2 points, 2.3 total points).”
2) Passing TD Notification. When a player throws a touchdown pass (shows length of pass) points scored depends on league rules (4, 8, etc.) (6, 12, etc.) Example: “Tom Brady TD pass (32 yds.), 3:49 1st Qtr. (+7.2 points, 14 total points).”
3) Passing Interception. When a player throws an interception points lost depends on league rules (2, 4, etc.) Example: “Tom Brady INT, 3:49 1st Qtr. (2 points, 4 total points).”
4) Rushing Stats Yards Notification. When a player scores fantasy points every x-yards rushing in the game x could vary depending on league scoring every 10 yds. (10, 20, etc.), 20 yds. (20, 40, etc.), etc. Example: “Lamar Miller rushes for 5 yard, totaling 57 rushing yds., 3:49 1st Qtr. (+0.5 points, 5.7 total points).”
5) Scoring Opportunity Notifications User receives a notification every time their players are in a scoring situation (can turn these notifications on/off) Passing, Rushing, and Receiving Red Zone When a fantasy user's quarterback, running back, receiver, or tight end's real team is in the red zone and the player is in the game. Example: “Lamar Miller is in the red zone, 3:49 1st Qtr.”
6) Kicking Field Goal Range. When a fantasy user's kicker's real team is inside the opponent's 35 yard line and it is fourth down (show length field goal would be) Example: “4th and 8 with Sebastian Janikowski in field goal range (47 yards), 3:49 1st Qtr.” Determine the length of field goal by adding the yard line and 17. So if the Raiders are on the opponent's 30 yard line it would be 47 yards.

It is envisioned that the software interface for the mobile application previously numbered 121, 221, 421 and 621, and in shown in FIGS. 1-6, will connect remotely to the online application server (not shown). This server will act as a conduit for users to communicate back and forth with the Data Server database (not shown). This allows it to be used by a plurality of users of any type of mobile device or smart phone. The application Server and the Data Server will be running on the application Server and Database (MongoDB) Server will be running on Ubuntu (Linux) operating system. The mobile application 621 could run on the operating system that ANDROID or IPHONE runs on, using a software framework to create menus, buttons, and other common functions expected of any mobile device. Embodiments of the invention provide the software for the mobile application developed with the APPLE and ANDROID development kits, Xcode and ANDROID SDK. The back-end application server will handle the user's requests and will be running Ubuntu (Linux) server. This application will allow users to have a seamless experience even if they switch from an IPHONE to an ANDROID or vice versa, and will be designed to interface with the hardware present on the IPHONE and ANDROID phones. It is envisioned in other embodiments that the application would run other devices that can emulate the ANDROID.

It is further envisioned that the mobile application previously numbered 121, 221, 421 and 621, also shown in FIGS. 1-6 may also be accessed via web pages using a (non-mobile device) desktop computer. Communication with the application server is required, so the mobile application will be making use of the cellular networks or WiFi using HTTPS to communicate. The system will also use the application server for users to log in. The mobile device used with this application should meet minimum operating system requirement or higher to install (download from an internet server) and run this mobile application.

One of the problems that unknown freelance journalists generating social media content have is that they lack large audiences to consume their social media content. The following is an alternative embodiment of the method in FIGS. 1-6, from which both the social media content generator gets instant notoriety (fame), massive distribution of their content, traffic, and a pipeline for a targeted audience in exchange for their original social media content news. Here, no money is exchanged, only news stories for fame and massive distribution or following.

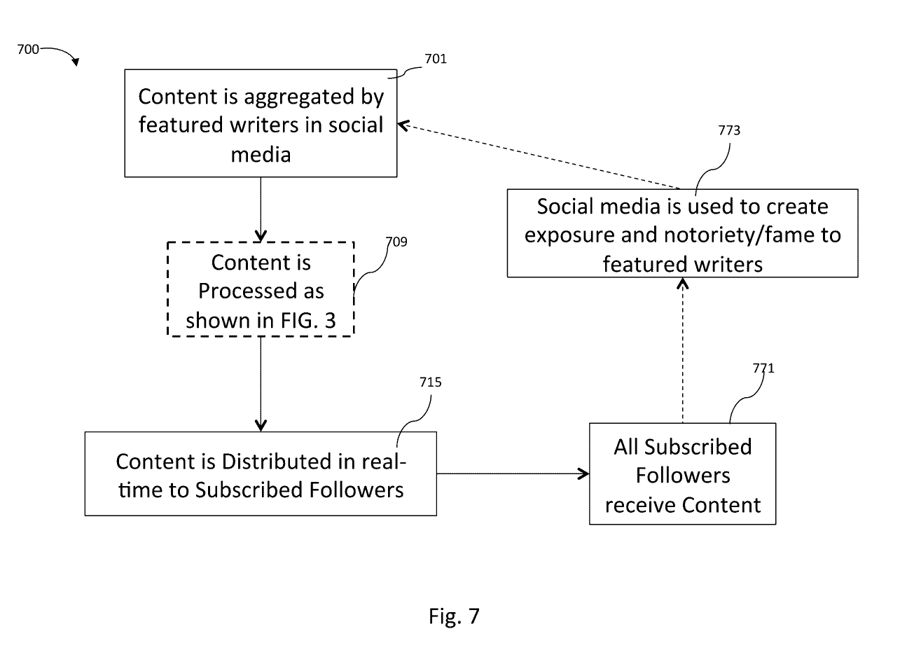

FIG. 7 depicts another embodiment of the automated stripping, aggregation, and distribution newsfeed method previously described in FIGS. 1-6. In order to generate social media content for the news feed, the inventive exposure-payback method 700 was invented. Here, the exposure-payback method 700 is as follows: (1) Social media content is created by featured writers in social media; (2) the social media content is processed as shown previously in FIG. 3; (4) the social media content is then distributed in real-time to all the subscribed followers of the app previously described in FIGS. 1-6 as 121, 221, 421 and 621; (5) the social media content is received by all the subscribed followers and they adopt the social media content associated with the featured writer's name; (6) in this way social media through all the subscribed followers create notoriety, fame, and exposure as payment for the social media content provided, hence no cash need to be exchanged.

An automated stripping, aggregation, and real-time distribution newsfeed method has been disclosed. The news “social media content” that is gathered, filtered, and distributed to subscribed follower both as mobile application and a computer website. Some of the used that can be provided with this novel system is for breaking news, sports news, financial news and more. In one of the embodiments, a fantasy sport league user using this method will get customized real-time articles, statistics, plays, scores about their fantasy league. Furthermore, an exposure-feedback method has been disclosed, that incorporates social media exposure as motivation to write social media content for the stripping, aggregation, and real-time distribution newsfeed method.

What we claim is:

1. A method of stripping, aggregation, and distribution of a posted social media content, the method comprising:
receiving the posted social media content;
filtering the posted social media content providing computational models to do the following:
transforming the posted social media content into Bigrams and Trigrams;
training a Term Frequency-Inverse Document Frequency (TF-IDF) model to learn the posted social media content;
representing the semantics of words in the posted social media content as a vector using a Word Vector Model;
representing the posted social media content as a vector using a Tweet Vector Model;
predicting the topic of a filtered social media content providing a generative probabilistic computational model;
and
matching the filtered social media content with a user to deliver the filtered social media content in real-time.

2. The method of claim 1, further comprising:
identifying the relevant users to receive the filtered social media content;
creating user notifications for the relevant users; and
pushing the filtered social media content with the user notification to a plurality of mobile devices.

3. The method of claim 1, wherein:
the probabilistic computational model uses a Topic Model that further comprises:
at least one neural network; and
at least one process that uses cosine distance to identify the posted social media content as repeat;

4. The method of claim 1, wherein:
the filtered social media content is sent at least one mobile device and at least one website.

5. The method of claim 1, wherein:
posted social media content includes breaking news, sport news, financial news and any combinations thereof.

6. The method of claim 1, wherein:
the method is designed for fantasy sports leagues.

7. A method of stripping, aggregation, and distribution of posted social media content, the method comprising:
filtering the posted social media content received providing computational models to do the following:
transforming the posted social media content into Bigrams and Trigrams;
predicting the posted social media content using an N-gram model;
representing the semantics of a word as a vector;
representing the posted social media content as a vector; and
predicting the topic of a filtered social media content with a neural network, and a process that uses the cosine distance to identify the posted social media content as a duplicate.

8. The method of claim 7, further comprising:
identifying the relevant users to receive the filtered social media content;
creating user notifications for the relevant users; and
pushing the filtered social media content with the user notification to a plurality of mobile devices.

9. The method of claim 7, wherein:
the at least one neural network uses supervised learning to classify the topics of tweets.

10. The method of claim 7, wherein:
the filtered social media content is sent to at least one mobile device and at least one website.

11. The method of claim 7, wherein:
social media content includes breaking news, sport news, financial news and any combinations thereof.

12. The method of claim 7, wherein:
the method is used by fantasy sports league players.

13. A method to receive a posted social media content from a social media content provider, the method comprising:
providing the social media content provider with notoriety by:
filtering the posted social media content providing computational models to do the following:
training and learn from the posted social media content;
recognizing patterns in language from the posted social media content;
deciding when the posted social media content is duplicative; and
matching a filtered social media content with a user to deliver personalized the filtered social media content in real-time.

14. The method of claim 13, wherein:
the filtered social media content is sent to at least one website.

15. The method of claim 13, wherein:
the filtered social media content is sent to at least one mobile device.

16. The method of claim 13, wherein:
the posted social media content includes breaking news, sport news, financial news and any combinations thereof.

17. The method of claim 13, wherein:
the method is used by fantasy sports league players.
